(19) United States
(12) Patent Application Publication
(10) Pub. No.: US 2012/0152114 A1
(43) Pub. Date: Jun. 21, 2012

(54) SYSTEM FOR ENHANCING AIR FILTER EFFICIENCY WITH EXTERNAL ELECTRICAL DUST CHARGING DEVICE

(76) Inventors: George Griffiths, Skelmersdale (DE); Geoffrey Norman Walter Gay, Fairfield, IA (US)

(21) Appl. No.: 13/254,129

(22) PCT Filed: Mar. 2, 2010
(86) PCT No.: PCT/GB2010/000369

§ 371 Date: Nov. 2, 2011

(51) Int. Cl. B03C 3/155

(52) U.S. Cl. 95/70; 96/55

(57) ABSTRACT

A system for enhancing air filter efficiency in an air conditioning apparatus comprising an air conditioning apparatus, having an associated air filter (13), and a dust charging device (5) that is external to the air conditioning apparatus for electrically charging dust particles in air that is drawn into the air conditioning apparatus. Also a method of improving air conditioning air filter efficiency comprising the step of providing a dust charging device for electrically charging dust externally of an air conditioning apparatus, having an associated air filter, and in a position to charge dust particles in air that is drawn into the air conditioning apparatus.

This invention concerns improvement/enhancement of air conditioning air filter performance.

Increasing public concern regarding the adverse health effects of air pollution has led to the widespread use of air filtration in air conditioning systems. Because all the air contained within a room or building passes through the air conditioning apparatus, it is an ideal opportunity to purify this air using an air filter fitted within the apparatus. However, space is limited in such installations and many existing air filters are designed only to remove larger dust particles in order to protect heat exchanger and other surfaces from the effects of dust deposition. Therefore such installations do not achieve the desired high efficiencies that are required to provide clean air for healthy respiration. Furthermore said installations are typically housed in slots or spaces within the air conditioning apparatus which may be too small for high efficiency filters.

Some filtration systems employ a dust charging device fitted within the air conditioning installation to enhance filtration efficiency. Such equipment is expensive and occupies considerable space. Such integrated dust charging equipment must charge the dust in transit and therefore to be effective must employ field charging techniques involving expensive and complex electrode arrays. In the confined space of an air conditioning apparatus, the airflow velocity is typically in the region of 2.5 metres per second (m/s) and the space available to the dust charging device is typically in the region of 25 millimetres (mm) in the direction of airflow; therefore the transit time is 10 milliseconds (ms). The dust particles must be electrically charged during this time of transit. The appropriate charging method in these circumstances is field charging and typically the charging electrodes need to be supplied with 2 milliamps (mA) of current at about 6,000 volts (V). A typical electrode array has 25 emitter electrodes. There are difficulties associated with designing and constructing such complex and high power electrode arrays within the available space.

Accordingly there are significant problems to be overcome in providing high-efficiency, low-cost, air filtration within an air conditioning system.

An object of the present invention is therefore to improve and/or enhance air filter performance in air conditioning apparatus.

According to the present invention there is a system for enhancing air filter efficiency in an air conditioning apparatus comprising an air conditioning apparatus, having an associated air filter, and a dust charging device that is external to the air conditioning apparatus for electrically charging dust particles in air that is drawn into the air conditioning apparatus.

The present invention also provides a method of improving air conditioning air filter efficiency comprising the step of providing a dust charging device for electrically charging dust externally of an air conditioning apparatus, having an associated air filter, and in a position to charge dust particles in air that is drawn into the air conditioning apparatus.

An air conditioning apparatus may be arranged in different ways. One form of air conditioning apparatus is a stand-alone apparatus, usually fitted in a window opening, to provide air conditioning for a single room. In such a situation the dust charging device is preferably provided in the room itself.

In domestic arrangements, a single air conditioning apparatus may be provided for several rooms, especially an entire house. Such an air conditioning apparatus will usually be sited out of the way, such as in a small room, and have ducts leading therefrom to grilles through which conditioned air is fed to the several rooms in the house. Air has to return to the air conditioning apparatus and access is usually provided to the site of the air conditioning apparatus in the form of a grille. It is envisaged that the dust charging device may be situated in proximity to said access, preferably in the same room as said access.

In modern air conditioning systems it is common not only to have ducts feeding conditioned air from air conditioning apparatus to a plurality of rooms, but also to have ducts returning air from the rooms to the air conditioning apparatus. In these circumstances, it is preferable to site the dust charging device in at least one room containing access to an air return duct, and preferably in every room.

In the present invention it is envisaged that a device will be provided for charging dust particles in the air in a building in which an air conditioning system draws the room/building air into an air conditioning apparatus including an air filter. In this way it is expected that higher levels of air cleaning efficiency may be achieved than can be achieved without dust charging. Furthermore, it is expected that air filter lifetime may be enhanced with larger numbers of dust particles being held on the filter before the efficiency falls below a minimum desired level. The dust charging device is positioned externally of the air conditioning apparatus. By not occupying any space within the air conditioning apparatus, the dust charging device may therefore be deployed at a lower cost than if the dust charging apparatus were integrated into the air conditioning apparatus.

With certain configurations of air return ductwork, some loss of dust particle charge may occur as the charged dust particles travel in the air stream along the duct. Such loss of charge may occur due to collision of the charged dust particles with the duct walls or by collision with uncharged particles adhering to the walls, resulting in loss of charge from the original particles, or the re-entrainment of uncharged particles from the duct wall deposit. In order to maintain high improved efficiencies provided by this invention it may in such circumstances be advantageous to place the filter at the entrance to the air return duct, or on or in the existing air return grille, or in a frame that can be securely attached to the grille, either internally or preferably externally. In this way the air carrying the charged dust particles passes through the filter before entering the duct and is therefore captured in the filter at an undiminished enhanced efficiency.

Preferably the dust charging device is a diffusion charging device. Diffusion charging devices are generally simpler than field charging devices and may operate with a one or two electrode system fed by a lower power high voltage supply. Diffusion charging electrodes may operate with corona currents in the region of about 1 microamp (μA). The generation of ozone, an undesirable by-product of corona action, is therefore greatly reduced in the approximate ratio of the corona currents, i.e. 1:2,000.

Alternatively, although a diffusion charging device is preferable, it may be that in some circumstances a dust charging device in the form of a field charging device is preferred to electrically charge dust particles. Such a charging device is preferably attached to an air inlet grille or duct of the air conditioning apparatus. Indeed an air filter may be associated with an entrance to an air return duct for the air conditioning apparatus, preferably by being attached to a grille at the entrance to the air return duct.

For a better understanding, the present invention will now be further described, by way of non-limiting example only, with reference to the accompanying drawings (not to scale), in which:

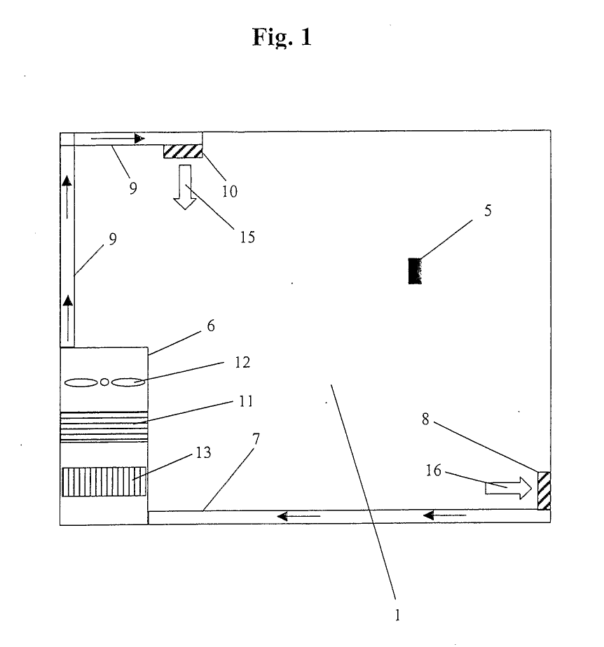

FIG. 1 shows a room containing an air conditioning apparatus;

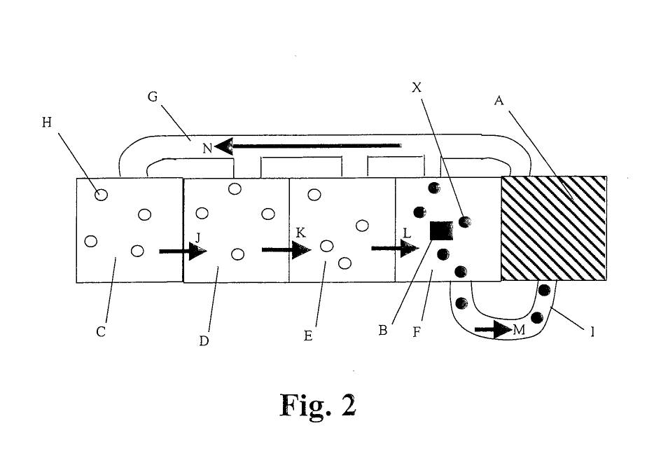

FIG. 2 shows a complex air conditioning arrangement for a building;

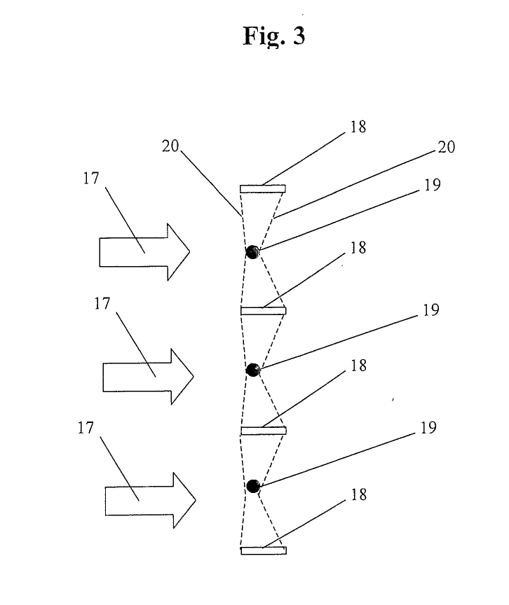

FIG. 3 illustrates the principle of field charging;

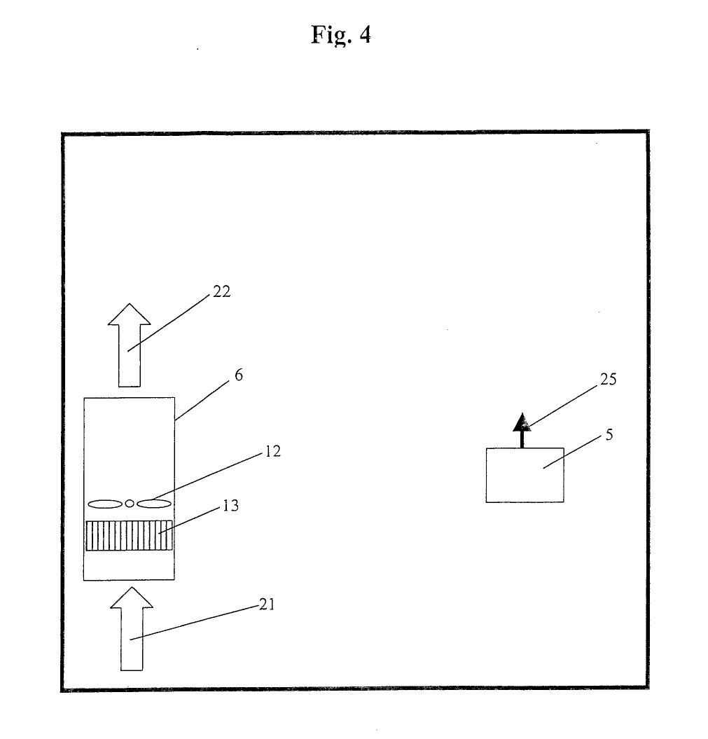

FIG. 4 illustrates the principle of diffusion charging;

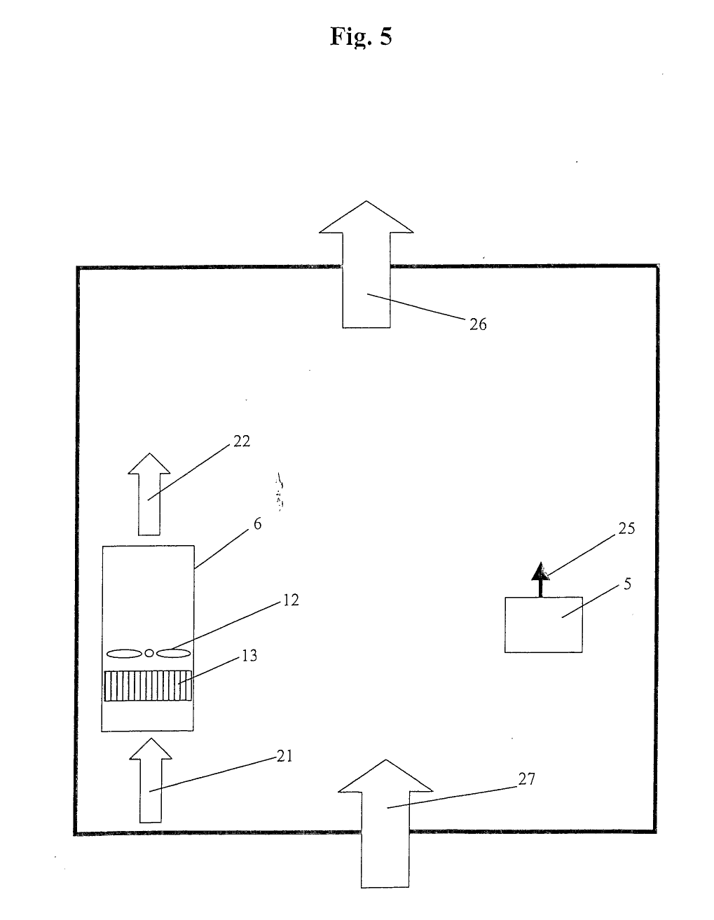

FIG. 5 shows a first embodiment of the invention;

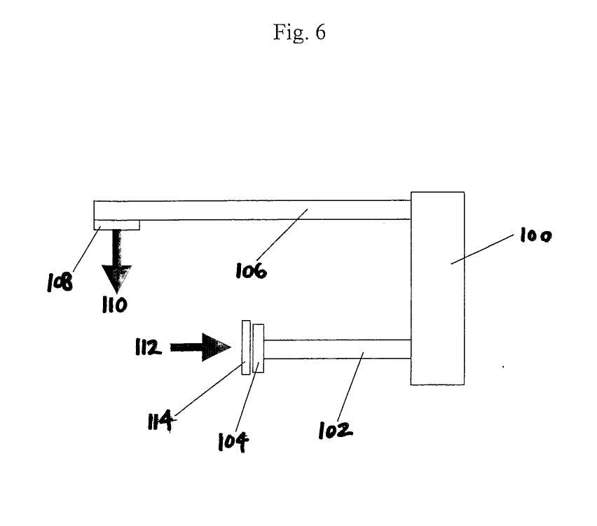

FIG. 6 shows a second embodiment of the invention; and

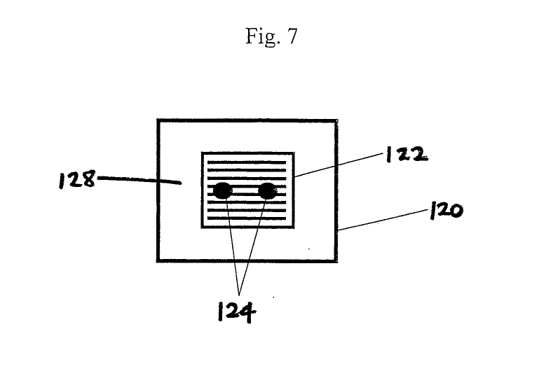

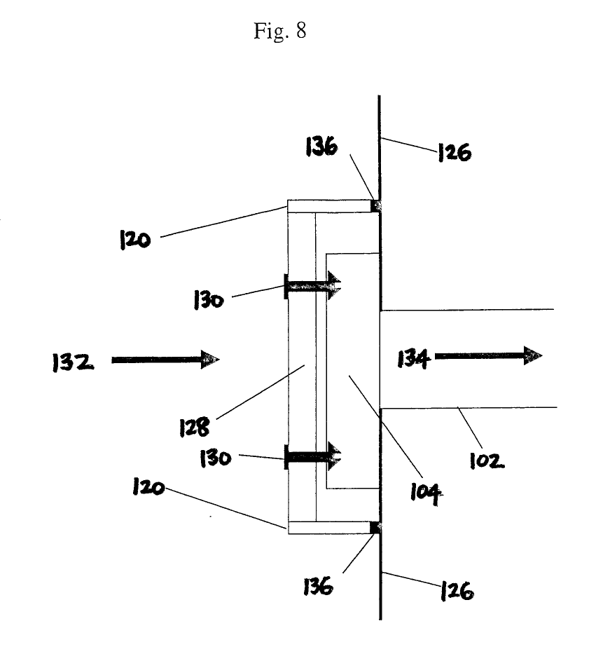

FIGS. 7 and 8 are front and sectional views respectively of an air filter for the embodiment of FIG. 6.

Referring to FIG. 1 of the accompanying drawings, there is shown an air conditioning system according to the invention. A room 1 contains an air conditioning apparatus or air cleaner 6. The air conditioning apparatus contains in series, i.e. sequentially, an air filter 13, one or more air conditioning stages 11, and a fan or air blower 12. The air conditioning apparatus draws room air through grille 8 into duct 7, which delivers the room air to the air conditioning apparatus as shown by arrow 16 and hence through air filter 13 and air conditioning stages 11 of the air conditioning apparatus. From the air conditioning apparatus, conditioned air is delivered back to the room via duct 9 and grille 10 as shown by arrow 15. The aforesaid air movement is effected by means of the air blower or fan 12.

The room also contains a dust charging device, in the form of an air ion generator 5 externally of the air conditioning apparatus 6 (remote therefrom in fact), to provide air ions to the room air, which charges the airborne dust particles. The air ions thus produced enter the room air and propagate throughout its volume. A process of diffusion charging then takes place, in which electric charge is transferred from the air ions to the dust particles. The charged particles are then deposited in the air filter 13 of the air conditioning apparatus 6 with a higher efficiency due to coulombic attraction between the air filter 13 and the charged dust particles.

In more complex buildings, containing a plurality of rooms and air supply ducts, the same process of diffusion charging can take place. Filter performance may be optimized if an air ion generator 5 is placed in all the rooms containing air return grilles 10. In such a building, not every room may or need be supplied with an air return grille or duct. However, provided a dust charging device is present in a room that is supplied with an air return grille or duct, then the air in rooms not supplied with a dust charging device 5 will flow into a room or rooms supplied with a dust charging device 5 and air return grille 10 or duct. The dust particles in that air will then become charged and return via the air return grille or duct to the filter within the air conditioning apparatus to be collected at improved efficiency. In this way all the air returning to the air filter is subjected to the diffusion charging process.

This process is illustrated with reference to FIG. 2 of the accompanying drawings, in which a building consists of four rooms C, D, E and F. An air conditioning apparatus A supplies conditioned air through air supply duct G to each room as shown by arrow N. Air supplied to room C flows through rooms D, E and F as shown by arrows J, K and L, and returns through air return duct I to the air conditioning apparatus as shown by arrow M. There is a similar pattern of air flow for air in rooms D and E. A dust charging device B is placed in room F and charges the dust particles moving through room F to the return duct I.

Uncharged dust particles are shown as white circles H, whilst charged dust particles are shown as black circles X. Thus it can be seen that dust particles from rooms without a dust charging device get charged in the room with a dust charging device. Provided all rooms with a return grille or duct are supplied with a dust charging device (in this case, only room F), then the filter performance will be optimised.

A typical example of such a building is a house with a number of rooms opening into a common area or hall. Typically the hall will contain a return grille and/or return duct. Each room of the house may be supplied with an air supply grille and/or duct. Thus as all the dust particles from each room flow into the hall (which they inevitably will do), they will be charged by a dust charging device placed in the hall, and will return to the air conditioning apparatus via the hall return grille.

FIG. 3 of the accompanying drawings illustrates the principle of field charging. An electrode system comprising an array of plates 18 and an array of wire corona electrodes 19 between the plates (of a diameter sufficiently small to support corona discharge along their length) is provided with a high electrical potential difference between the wires and the plates sufficient to induce corona discharge on the wires and ionization of air in the immediate vicinity. The air ions so produced transit the air space in a fan shaped distribution shown approximately by the dotted lines 20. The room air is caused to pass through the electrode array as shown by arrows 17 and inevitably the entrained dust particles are bombarded by the air ions and therefore take up electrical charge. Other embodiments of this field charging principle may employ electrodes of different geometries, such as, for example, sharp pins or stamped metal sheet.

FIG. 4 of the accompanying drawings illustrates the principle of diffusion charging. A dust charging device in the form of an air ion generator 5 houses a high voltage electrical supply that maintains one or more sharp pin corona electrodes 25 at a high potential with respect to earth causing ionization of air in the immediate vicinity and subsequent emission of air ions into the room air. The air ions thus produced propagate throughout the room air volume. A process of diffusion charging then takes place, in which electric charge is transferred from the air ions to the dust particles. The charged dust particles may then be deposited in the filter 13 of the air conditioning apparatus or air cleaner 6, being drawn therethrough by the fan or blower 12, as shown by arrows 21 and 22, with a higher efficiency due to coulombic attraction between the air filter 13 and the charged dust particles.

Turning to FIG. 5 of the accompanying drawings, there is shown a room (of size 22.5 cubic metres (m³)) provided with a dust charging device in the form of an air ion generator 5 with a corona electrode 25, and an air conditioning apparatus or air cleaner apparatus 6 containing a filter 13 and fan or blower 12. Air is urged from the room through the filter by the fan at a velocity of 2 metres per second (m/s) as shown by arrows 21 and 22. Additionally air is supplied to the room as shown by arrow 27 and this airflow exits the room as shown by arrow 26. The airflow through the room is 1,364 cubic metres per hour, which corresponds to a typical air throughput of a whole house air conditioning apparatus. The filter 13 is an electrostatic filter; the filtration efficiency without dust particle charging was measured to be 23% for 0.3 micrometre (μm) dust particles. Two minutes after switching on the ion generator, the filter efficiency was measured to be 93% for 0.3 micrometre (μm) dust particles. Thus, an improvement of 70% in filter efficiency was obtained in conditions typical of a conventional air conditioning system. Because the time taken after switching on the ion generator to achieve optimum enhanced efficiency is short, the ion generator only needs to be switched on when the air conditioning apparatus fan or air cleaner fan is operating, thus saving energy.

It will be readily appreciated that the present invention may be applied to any air conditioning apparatus containing an air filter whether or not the apparatus utilizes ducts for the delivery and/or return of conditioned air. For example space inside a mini-split or high wall air conditioning apparatus is at an even greater premium than in whole-house air conditioning apparatus, and the external positioning of diffusion charging apparatus is therefore advantageous.

In addition the present invention may be applied to any air cleaning device where it is advantageous to charge the dust particles externally to the air cleaner containing the air filter.

It will further be appreciated that any method of dust charging can be deployed according to this invention, externally of the air conditioning or other air filter containing apparatus, for example, arrays of field charging electrodes operating in conjunction with a fan, etc., drawing or blowing the room air through the electrode array thus charging the dust particles.

Referring to FIG. 6 an air conditioning apparatus 100 is supplied with room air via air return duct 102 and air return grille 104. The conditioned air is supplied to the room or rooms of a building via air supply duct 106 and air supply grille 108. The air enters the room as shown by arrow 110 and returns to the air conditioning apparatus as shown by arrow 112. According to the present invention, a filter 114 is placed in front of the return duct to filter the air before entry into the return duct 102. This filter 114 may be mounted in a supplementary frame which is supplied with a means of fixing it to an existing grille, such as with flexible clips which engage in perforations of the existing return grille 104. Alternatively filter 114 may be placed in a frame which replaces the existing return grille 104 and fixes in a like manner to the entrance of the return duct 102. Further alternatively, filter 114 may be fitted in a frame located within the entrance of the return duct 102 itself. In all these cases the filter 114 may alternatively be self-supporting and fit without the need for a frame.

The frame or filter can be manufactured in standard sizes that accommodate the existing sizes of air return grilles or ducts, with the possibility that the frame or filter is larger than some sizes of standard grille or duct, so that one size or filter or filter frame can fit over a number of different sizes of grille or duct. In this case the air filtration can be enhanced by fitting a flexible seal or gasket around the perimeter of the filter or frame so that air by-pass is eliminated and filter efficiency kept high.

An example of such an arrangement is shown in FIGS. 7 and 8 of the drawings. A filter or filter frame 120 is placed over an existing air return grille 122 and fixed in place using one or more clips 124 which attach to perforations in the existing air return grille. The existing air return grille 104 is fixed to the return air duct 102 and/or the wall 126. Air filter 128 is mounted in the filter frame 120. The frame 120 is fixed to the return air grille by one or more clips 130. Air containing charged dust particles enters the filter as shown by arrow 132, passes through the filter where the dust is collected at enhanced efficiency, and then through the return grille to the air return duct 102 as shown by arrow 124 and then to the air conditioning apparatus whence it returns to the room. The filter frame is provided with a compressible gasket 136 around its perimeter to prevent entrance of unfiltered air into the duct system. It will be appreciated that in the building with more than one air return grille, such a filter and/or frame may be fitted to each return grille to optimize air filtration.

1. A system for enhancing air filter efficiency in an air conditioning apparatus comprising an air conditioning apparatus, having an associated air filter, and a dust charging device that is external to the air conditioning apparatus for electrically charging dust particles in air that is drawn into the air conditioning apparatus.

2. A system as claimed in claim 1 wherein the air conditioning apparatus is a stand-alone apparatus to provide air conditioning for a single room and the dust charging device is provided in the room itself.

3. A system as claimed in claim 1 comprising a single air conditioning apparatus for several rooms having ducts leading therefrom to grilles through which conditioned air is fed to the several rooms, and access for air return thereto, wherein the dust charging device is situated in proximity to said access.

4. A system as claimed in claim 3 wherein the dust charging device is in the same room as the said access.

5. A system as claimed in claim 3 wherein said access is provided by a grille leading to the air conditioning apparatus.

6. A system as claimed in claim 1 comprising an air conditioning apparatus having ducts therefrom to feed conditioned air to a plurality of rooms and air return ducts thereto return air from the said plurality of rooms to the air conditioning apparatus, wherein a dust charging device is situated in at least one room containing access to an air return duct.

7. A system as claimed in claim 6 wherein a dust charging device is situated in every room.

8. A system as claimed in claim 1 wherein the dust charging device is a diffusion charging device.

9. A system as claimed in claim 1 wherein the dust charging device is a field charging device.

10. A system as claimed in claim 9 wherein the field charging device is attached to an air inlet or duct of the air conditioning apparatus.

11. A system as claimed in claim 6 having an air filter associated with an entrance to an air return duct for the air conditioning apparatus.

12. A system as claimed in claim 11 having an air filter attached to a grille at the entrance to the air return duct.

13. A method of improving air conditioning air filter efficiency comprising the step of providing a dust charging device for electrically charging dust externally of an air conditioning apparatus, having an associated air filter, and in a position to charge dust particles in air that is drawn into the air conditioning apparatus.

14. A method as claimed in claim 13 wherein the air conditioning apparatus is a stand-alone apparatus to provide air conditioning for a single room and the dust charging device is provided in the room itself.

15. A method as claimed in claim 13 wherein a single air conditioning apparatus is provided for several rooms having ducts leading therefrom to grilles through which conditioned air is fed to the several rooms and access for air return thereto, wherein the dust charging device is situated in proximity to said access.

16. A method as claimed in claim 15 wherein the dust charging device is provided in at least one of the rooms.

17. A method as claimed in claim 15 wherein said access is provided by a grille leading to the air conditioning apparatus.

18. A method as claimed in claim 13 comprising providing an air conditioning apparatus having ducts therefrom to feed conditioned air to a plurality of rooms and air return ducts thereto return air from the said plurality of rooms to the air conditioning apparatus, wherein the dust charging device is situated in at least one room containing access to an air return duct.

19. A method as claimed in claim 13 wherein the dust charging device is a diffusion charging device.

20. A method as claimed in claim 13 wherein the dust charging device is a field charging device.

21. A method as claimed claim 15 comprising positioning an air filter at an entrance to an air return duct for the air conditioning apparatus.

22. A method as claimed in claim 21 comprising attaching an air filter to a grille at the entrance to the air return duct.

23.-24. (canceled)
